(19) United States
(12) Patent Application Publication
(10) Pub. No.: US 2024/0167674 A1
(43) Pub. Date: May 23, 2024

(54) Nail Table Lighting Device

(71) Applicant: Tjay Nguyen, Anaheim, CA (US)

(72) Inventor: Tjay Nguyen, Anaheim, CA (US)

(21) Appl. No.: 18/477,147

(22) Filed: Sep. 28, 2023

Related U.S. Application Data
(60) Provisional application No. 63/426,866, filed on Nov. 21, 2022.

(51) Int. Cl. F21V 33/00; A45D 29/18; A47B 21/06; A47B 37/00

(52) U.S. Cl. CPC F21V 33/0012; A45D 29/18; A47B 21/06; A47B 37/00; F21V 33/0056; F21Y 2115/10

(57) ABSTRACT

The present invention relates to a nail table lighting device with a generally L-shaped or U-shaped frame that extends over a nail table such that the light adequately illuminates the working surface of a table. In addition, the device may be comprised of at least one power receptacle that allows a user to plug in and power various nail-related tools and accessories. In this manner, the shape of the frame and the positioning of the light on the inside surface of the frame ensures a nail table is properly illuminated.

### CROSS-REFERENCE TO RELATED APPLICATION

The present application claims priority to, and the benefit of, U.S. Provisional Application No. 63/426,866, which was filed on Nov. 21, 2022, and is incorporated herein by reference in its entirety.

### FIELD OF THE INVENTION

The present invention relates generally to the field of lighting devices. More specifically, the present invention relates to a nail table lighting device with a generally L-shaped or U-shaped frame that extends over a nail table such that the light adequately illuminates the working surface of a table. In addition, the device may be comprised of at least one power receptacle that allows a user to plug in and power various nail-related tools and accessories. Accordingly, the present disclosure makes specific reference thereto. Nonetheless, it is to be appreciated that aspects of the present invention are also equally applicable to other like applications, devices, and methods of manufacture.

### BACKGROUND

Many manicurists and nail technicians find it hard to see clearly when performing a manicure or other hand services due to a lack of adequate lighting. This can lead to eye strain and can also lead to long-term eye damage. In addition, lack of proper lighting can cause fatigue and overall tiredness for manicurists and nail technicians.

Therefore, there exists a long-felt need in the art for a lighting device for a nail salon. More specifically, there exists a long-felt need in the art for a manicure table lighting device that provides adequate lighting to a manicure (or other hand service-related) table. There also exists a long-felt need in the art for a manicure table lighting device that can be applied to an existing manicure (or other hand service-related) table. Further, there exists a long-felt need in the art for a manicure table lighting device that is visually appealing. In addition, there exists a long-felt need in the art for a manicure table lighting device that can be applied to an existing manicure (or other hand service-related) table, wherein the device provides a power outlet for nail-related tools and devices.

The subject matter disclosed and claimed herein, in one embodiment thereof, comprises a nail table lighting device. The device is primarily comprised of a frame with at least one light on at least one inside surface of the frame. The frame is preferably generally L-shaped or U-shaped such that the light adequately illuminates the working surface of a table via the portion of the frame that extends over/next to the table. The frame may be comprised of at least one indicia and may be made from a plurality of materials to achieve an aesthetic finish. In addition, the device may be comprised of at least one power receptacle that allows a user to plug in and power various nail-related tools and accessories.

In this manner, the nail table lighting device of the present invention accomplishes all the foregoing objectives and provides a manicure table lighting device that provides adequate lighting to a manicure (or other hand service-related) table. In addition, the modern design of the device makes it visually appealing. Furthermore, the device provides a power outlet for nail-related tools and devices.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a nail table lighting device. The device is primarily comprised of a frame with at least one light on at least one inside surface of the frame. The frame is preferably generally L-shaped or U-shaped such that the light adequately illuminates the working surface of a table. The frame may have a plurality of finishes (or may be made from material) such as, but not limited to, wood, metal, precious metal, plastic, or any other natural or synthetic finish or material. The frame may also be comprised of at least one indicia such as, but not limited to, patterns, logos, emblems, images, symbols, designs, letters, numbers, words, characters, animals, advertisements, brands, etc.

The frame is preferably comprised of at least one power receptacle having at least one port. The port may be any female port known in the art such as, but not limited to, a USB port, a 110v/240v outlet, or any other power outlet style known in the art. The receptacle and ports allow nail accessories to be easily plugged in to receive power.

The frame is also comprised of at least one light that is preferably an LED light having at least one brightness level. The light may be positioned on the inside surface of the frame. This allows the light to illuminate the working area on the table. The light and brightness levels of the light may be controlled by at least one button located on the frame or via a voice command detected by at least one microphone.

The frame may also be comprised of at least one speaker. The speaker is preferably a wireless Bluetooth speaker that allows a user to play music. Like the light, the speaker may be controlled by the button and/or voice commands via the microphone.

The device and all components receive electrical power via at least one power cord. The power cord may be any style known in the art but is preferably a 110v/240v power cord. The cord may be located on any location within or outside of the frame. In different embodiments, the device can be attached to an existing nail table or may be integrally manufactured into any nail table.

Accordingly, the nail table lighting device of the present invention is particularly advantageous as it provides a manicure table lighting device that provides adequate lighting to a manicure (or other hand service-related) table that can be applied to said table. Further, the device is visually appealing and provides a power outlet for nail-related tools and devices. In this manner, the nail table lighting device overcomes the limitations of existing nail salon lighting known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an enhanced perspective view of one potential embodiment of a nail table lighting device of the present invention while attached to a table in accordance with the disclosed architecture;

FIG. 2 illustrates a perspective view of one potential embodiment of a nail table lighting device of the present invention while attached to a table in accordance with the disclosed architecture; and

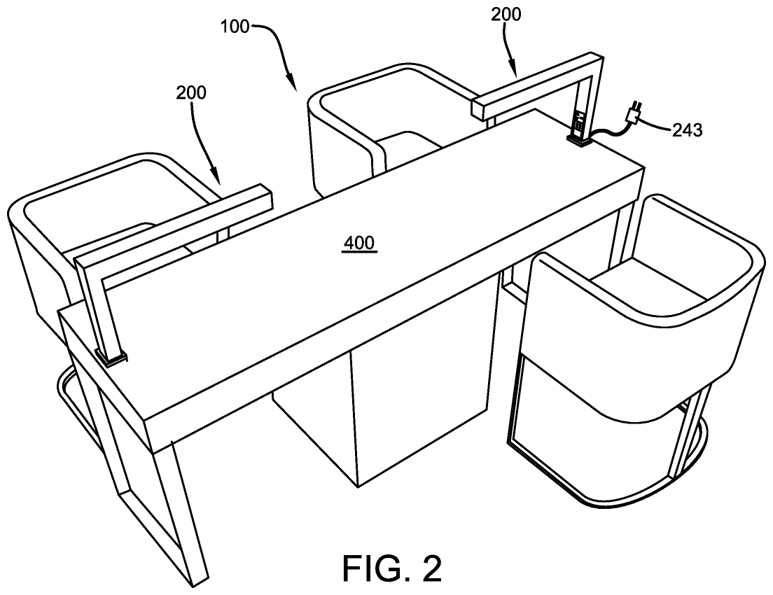

FIG. 3 illustrates a perspective view of one potential embodiment of a nail table lighting device of the present invention while attached to a table in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a lighting device for a nail salon. More specifically, there exists a long-felt need in the art for a manicure table lighting device that provides adequate lighting to a manicure (or other hand service-related) table. There also exists a long-felt need in the art for a manicure table lighting device that can be applied to an existing manicure (or other hand service-related) table. Further, there exists a long-felt need in the art for a manicure table lighting device that is visually appealing. In addition, there exists a long-felt need in the art for a manicure table lighting device that can be applied to an existing manicure (or other hand service-related) table, wherein the device provides a power outlet for nail-related tools and devices.

The present invention, in one exemplary embodiment, is comprised of a nail table lighting device primarily comprised of a frame with at least one light on at least one inside surface of the frame. The frame is preferably generally L-shaped or U-shaped such that the light adequately illuminates the working surface of a table. The frame may have a plurality of finishes (or may be made from material) such as, but not limited to, wood, metal, precious metal, plastic, or any other natural or synthetic finish or material and also be comprised of at least one indicia such as, but not limited to, patterns, logos, emblems, images, symbols, designs, letters, numbers, words, characters, animals, advertisements, brands, etc.

The frame is preferably comprised of at least one power receptacle having at least one port. The port may be any female port known in the art such as, but not limited to, a USB port, a 110v/240v outlet, or any other power outlet style known in the art. Accordingly, the receptacle and ports allow nail accessories to be easily plugged in to receive power.

The frame is also comprised of at least one light that is preferably an LED light having at least one brightness level. The light may be positioned on the inside surface of the frame in order to illuminate the working area on the table. The light and brightness levels of the light may be controlled by at least one button located on the frame or via a voice command detected by at least one microphone.

The frame may also be comprised of at least one speaker. The speaker is preferably a wireless Bluetooth speaker that allows a user to play music. Like the light, the speaker may be controlled by the button and/or voice commands via the microphone.

The device and all components receive electrical power via at least one power cord. The power cord may be any style known in the art but is preferably a 110v/240v power cord. The cord may be located on any location within or outside of the frame. In different embodiments, the device can be attached to an existing nail table or may be integrally manufactured into any nail table.

Accordingly, the nail table lighting device of the present invention is particularly advantageous as it provides a manicure table lighting device that provides adequate lighting to a manicure (or other hand service-related) table. Further, the device is visually appealing and provides a power outlet for nail-related tools and devices. In this manner, the nail table lighting device overcomes the limitations of existing nail salon lighting known in the art.

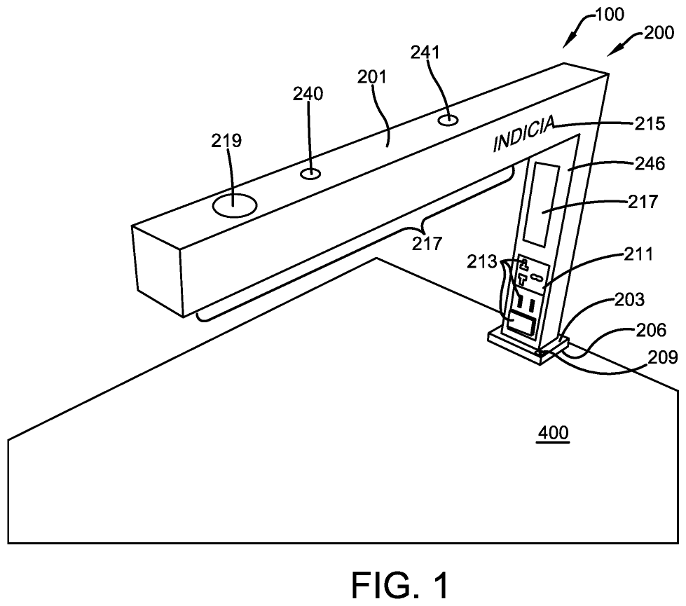

Referring initially to the drawings, FIG. 1 illustrates an enhanced perspective view of one potential embodiment of a nail table lighting device 100 of the present invention while attached to a table in accordance with the disclosed architecture. The device 100 is primarily comprised of a frame 201,301 with at least one light 217,317 on at least one inside surface 246,346 of the frame 201,301. The frame 201,301 is preferably generally L-shaped or U-shaped such that the light 217,317 adequately illuminates the working surface of a table 400. The frame 201,301 also may be comprised of at least one power receptacle 211,311 that allows a nail-related device to be plugged into the device 100 to receive power.

A first embodiment 200 of the device 100 is comprised of a frame 201 with at least one power receptacle 211 and at least one light 217. In this embodiment, the frame 201 is comprised of an upside-down L-shape. However, the frame 210 may be any shape known in the art that allows a portion of the frame 201 to extend over a table 400 the device 100 is secured to. The frame 201 may have a plurality of finishes (or may be made from material) such as, but not limited to, wood, metal, precious metal, plastic, or any other natural or synthetic finish or material. The frame 201 may also be comprised of at least one indicia 215 such as, but not limited to, patterns, logos, emblems, images, symbols, designs, letters, numbers, words, characters, animals, advertisements, brands, etc.

In one embodiment, the frame 201 is comprised of at least one mounting plate 203. The mounting plate 203 allows the frame 201 to attach to a nail table 400 (of any style known in the art). In one embodiment, the frame 201 is fixedly attached to the table 400. In another embodiment, a bottom surface 206 of the mounting plate 203 is comprised of at least one fastener 209. The fastener 209 may be any fastener type known in the art that allows the mounting plate 203 to attach to the table 400 such as, but not limited to, adhesive, hook and loop, magnet, etc. In one embodiment, the fastener 209 may be at least one screw or bolt that allows the frame 201 to be screwed to the table 400.

The frame 201 is preferably comprised of at least one power receptacle 211. The power receptacle 211 is comprised of at least one port 213. The port 213 may be any female port 213 known in the art such as, but not limited to, a USB port, a 110v/240v outlet, or any other power outlet style known in the art. The receptacle 211 and ports 213 allow nail accessories to be easily plugged in to receive power.

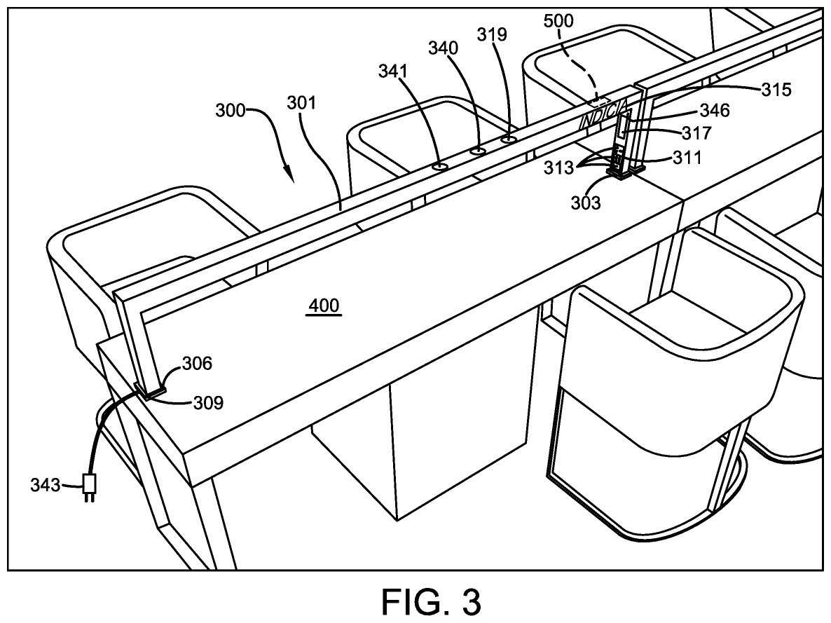

The frame 201 is also comprised of at least one light 217. The light 217 is preferably an LED light. The light 217 may have at least one brightness level and may illuminate any color. The light 217 may be positioned on the inside surface 246 of the frame 201 in order to illuminate the working area on the table 400, as seen in FIG. 3.

The light 217 and brightness levels of the light 217 may be controlled by at least one button 241 located on the frame 201. Alternatively, the frame 201 may be comprised of at least one microphone 240 that allows the functions of the light 217 to be controlled via voice commands using a processor 500 that is in electrical communication with the light 217.

The frame 201 may also be comprised of at least one speaker 219. The speaker 219 is preferably a wireless Bluetooth speaker that allows a user to play music. The speaker 219 may be controlled by the button 241 and/or voice commands via the microphone 240.

The power receptacles 211, light 217, speaker 219, microphone 240, and processor 500 receive electrical power via at least one power cord 243. The power cord 243 may be any style known in the art but is preferably a 110v/240v power cord. The cord 243 may be located on any location within or outside of the frame 201.

A second embodiment 300 of the device 100 is comprised of a frame 301 with at least one power receptacle 311 and at least one light 317. In this embodiment, the frame 301 is comprised of an upside-down U-shape, as seen in FIG. 3. However, the frame 310 may be any shape known in the art that allows a portion of the frame 301 to extend over a table 400 the device 100 is secured to. The frame 301 may have a plurality of finishes (or may be made from material) such as, but not limited to, wood, metal, precious metal, plastic, or any other natural or synthetic finish or material. The frame 301 may also be comprised of at least one indicia 315 such as, but not limited to, patterns, logos, emblems, images, symbols, designs, letters, numbers, words, characters, animals, advertisements, brands, etc.

In one embodiment, the frame 301 is comprised of at least one mounting plate 303. The mounting plate 303 allows the frame 301 to attach to a nail table 400 (of any style known in the art). In one embodiment, the frame 301 is fixedly attached to the table 400. In another embodiment, a bottom surface 306 of the mounting plate 303 is comprised of at least one fastener 309. The fastener 309 may be any fastener type known in the art that allows the mounting plate 303 to attach to the table 400 such as, but not limited to, adhesive, hook and loop, magnet, etc. In one embodiment, the fastener 309 may be at least one screw or bolt that allows the frame 301 to be screwed to the table 400.

The frame 301 is preferably comprised of at least one power receptacle 311. The power receptacle 311 is comprised of at least one port 313. The port 313 may be any female port 313 known in the art such as, but not limited to, a USB port, a 110v/240v outlet, or any other power outlet style known in the art. The receptacle 311 and ports 313 allow nail accessories to be easily plugged in to receive power.

The frame 301 is also comprised of at least one light 317. The light 317 is preferably an LED light. The light 317 may have at least one brightness level and may illuminate any color. The light 317 may be positioned on the inside surface 346 of the frame 301 in order to illuminate the working area on the table 400.

The light 317 and brightness levels of the light 317 may be controlled by at least one button 341 located on the frame 301. Alternatively, the frame 301 may be comprised of at least one microphone 340 that allows the functions of the light 317 to be controlled via voice commands using a processor 500 that is in electrical communication with the light 317.

The frame 301 may also be comprised of at least one speaker 319. The speaker 319 is preferably a wireless Bluetooth speaker that allows a user to play music. The speaker 319 may be controlled by the button 341 and/or voice commands via the microphone 340.

The power receptacle 311, light 317, speaker 319, microphone 340, and processor 500 receive electrical power via at least one power cord 343. The power cord 343 may be any style known in the art but is preferably a 110v/340v power cord. The cord 343 may be located on any location within or outside of the frame 301.

It should be appreciated that the table 400 may be any size, shape, material, style, and configuration of table known in the art. Further, the light 217,317 may be extended, recessed, or flush with each frame 201,301 in different embodiments.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “nail table lighting device” and “device” are interchangeable and refer to the nail table lighting device 100 of the present invention.

Notwithstanding the foregoing, the nail table lighting device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the nail table lighting device 100 as shown in the FIGS. are for illustrative purposes only, and that many other sizes and shapes of the nail table lighting device 100 are well within the scope of the present disclosure. Although the dimensions of the nail table lighting device 100 are important design parameters for user convenience, the nail table lighting device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A nail table lighting device comprising:
a frame;
a light positioned on an inside surface of the frame;
a power receptacle comprised of a port;
a button; and
a power cord.

2. The nail table lighting device of claim 1, wherein the port is comprised of a USB port.

3. The nail table lighting device of claim 1, wherein the port is comprised of a female 110V or 240V outlet.

4. The nail table lighting device of claim 1, wherein the light is comprised of an LED light.

5. The nail table lighting device of claim 4, wherein the light is comprised of a brightness level.

6. The nail table lighting device of claim 1 further comprised of a table.

7. The nail table lighting device of claim 1, wherein the frame is comprised of a metal material.

8. A nail table lighting device comprising:
an upside-down U-shaped frame;
a light positioned on an inside surface of the upside-down U-shaped frame;
a power receptacle comprised of a port;
a button; and
a power cord.

9. The nail table lighting device of claim 8, wherein the upside-down U-shaped frame is comprised of a wood, a metal, a precious metal, a plastic, a natural or a synthetic material.

10. The nail table lighting device of claim 8, wherein the upside-down U-shaped frame is comprised of an indicia.

11. The nail table lighting device of claim 8, wherein the light is flush with the inside surface.

12. A nail table lighting device comprising:
a frame;
a light positioned on an inside surface of the frame;
a power receptacle comprised of a port;
a speaker;
a microphone;
a mounting plate;
a fastener;
a button; and
a power cord.

13. The nail table lighting device of claim 12, wherein a bottom surface of the mounting plate is comprised of a fastener.

14. The nail table lighting device of claim 13, wherein the fastener is comprised of an adhesive fastener.

15. The nail table lighting device of claim 12, wherein a function of the speaker is controlled by a voice command detected via the microphone.

16. The nail table lighting device of claim 12, wherein a function of the light is controlled by a voice command detected via the microphone.

17. The nail table lighting device of claim 12, wherein the light can illuminate a color.

18. The nail table lighting device of claim 12, wherein the speaker is comprised of a Bluetooth speaker.

19. The nail table lighting device of claim 12, wherein the light is recessed within the frame.

20. The nail table lighting device of claim 12 further comprised of a table.
